(19) United States
(12) Patent Application Publication
(10) Pub. No.: US 2012/0255626 A1
(43) Pub. Date: Oct. 11, 2012

(54) HOSE REEL PULL HANDLE TO FRAME INTERFACE

(75) Inventor: PETER ARCATI, Dillsburg, PA (US)

(73) Assignee: AMES TRUE TEMPER, INC., CAMP HILL, PA (US)

(21) Appl. No.: 13/082,524

(22) Filed: Apr. 8, 2011

(51) Int. Cl. B65H 75/18; G05G 1/08

(52) U.S. Cl. 137/355.26; 74/545

(57) ABSTRACT

A hose reel having a lower frame assembly with two side frame assemblies and a handle assembly with arms that are disposed in-line with the side frame assemblies is provided. The handle assembly includes two annular couplings, one disposed at the distal end of each handle assembly arm. The annular couplings include a circular opening. These openings may be disposed about the axis of rotation of a basket assembly, about which the hose is wound, and/or the rotational coupling between the basket assembly and the frame assembly. Having a handle assembly coupling at this location reduces the amount of torque between the handle assembly and the frame assembly when the hose reel is being pushed/pulled. Further, as the handle assembly arms are in line with the side frame assemblies, this configuration is generally considered more attractive than the offset handles of the prior art.

### FIELD OF THE INVENTION

The present invention relates to a hose reel and, more specifically, to a hose reel having a sturdy and eye-pleasing coupling between the hose reel frame assembly and the handle assembly.

### BACKGROUND OF THE INVENTION

A portable hose reel includes a frame assembly that supports a rotatable basket assembly. The basket assembly is structured to support a length of hose wrapped thereabout, i.e. the hose reel hose. A supply hose is coupled to the hose reel and a water supply. The hose reel hose is in fluid communication with the supply hose. The frame assembly, typically, includes at least one pair of wheels. In this configuration, the hose reel, while coupled to the supply hose, may be transported to various locations in a yard, field, etc. (hereinafter “yard”). The hose reel hose may then be unwound so as to reach further than the supply hose. When the user completes watering one portion of the yard, the hose reel hose is wound about the basket assembly so that the hose reel may be transported to another location.

Given that hose reels may be used often in dry climates and/or during a dry spell, users typically leave the hose reel in the yard between uses. Further, users of hose reels, generally, care about the appearance of the yard and objects therein, including the hose reel itself. Generally, hose reels are made from either metal or plastic. Metal hose reels may be made to be decorative, e.g. having a floral pattern incorporated into the hose reel frame, or may be a sleek tubular frame. Such hose reels are generally considered to be attractive. Metal hose reels are, however, expensive and prone to environmental degradation. Plastic hose reels are less expensive and are resistant to environmental degradation. Plastic hose reels are, however, considered by many to be unattractive.

For example, a common type of portable hose reel has two similar side frame assemblies, each having legs and a hub socket. The basket assembly, which typically has a barrel disposed between two hubs, is rotatably disposed between the spaced sockets. Such hose reels further include one or two pairs of wheels at the bottom of the side frame assemblies and a handle assembly. The handle assembly is, typically, an inverted U-shaped element having a bight and two arms extending therefrom. The bight is used as a grip/handle. Each arm may be rotatably coupled to one of the side frame assemblies. In this configuration, the handle assembly may be moved between an upper position, typically used to transport, i.e. push/pull, the hose reel between locations, and a lower position, typically used for storage or while the hose is in use. The handle assembly body is typically sized to be slightly more narrow than the spacing of the side frame assemblies. The distal ends of the handle assembly are then coupled to the inner sides of the frame assembly. That is, the handle assembly body arms are not aligned with the side frame assemblies.

There are disadvantages to this configuration. For example, when pulling the hose reel (which may include an extended hose filled with water) the side frame assemblies are subjected to stress. That is, because the weight of the hose is applied to the frame at the basket assembly sockets and the handle assembly is coupled to the frame assembly at another location, there is torque applied to the frame assemblies at multiple locations. The stress and/or torque degrades the frame assembly. Further, many users consider the non-aligned handle to be unattractive.

A limited number of hose reels have attempted to address these problems by coupling the arms of the handle assembly to the top of the side frame assemblies. This configuration has its own disadvantages. First, the coupling between the handle assembly and frame is spaced further from the basket assembly. This configuration results in more torque between the handle assembly and frame thereby requiring a more robust, and therefore more expensive, frame coupling. That is, the coupling must have either thicker components, and/or be made from a stronger material such as metal. Further, while the hose reel could have a locking mechanism to maintain the handle in the upper and/or lower position, such hose reels typically have the handle rotate forward. This configuration allows the frame assembly to act as a stop for the handle rotation. That is, for example, the handle assembly is coupled to the side frame assemblies by a hinge located on the front side of the handle assembly. When the handle assembly is in the upper position, the handle arms abut the top of the side frame assemblies preventing further rotation toward the back side of the hose reel. When the user wished to lower the handle, the user must move to the front of the hose reel and pull the handle assembly forward so that the handle assembly folds down over the side frame assemblies. This is more time consuming than the typical hose reel wherein the handle is always disposed on the back side of the hose reel, where the user is typically located when the hose reel is being transported. Moreover, the exposed hinge, like the offset coupling, is typically considered to be unattractive.

### SUMMARY OF THE INVENTION

The purpose of the present disclosure is to provide for a hose reel handle assembly having arms that are disposed in-line with the side frame assemblies. The handle assembly includes two annular couplings, one disposed at the distal end of each handle assembly arm. The annular couplings include a circular opening. These openings may be disposed about the axis of rotation of the basket assembly and/or the rotational coupling between the basket assembly and the frame assembly. Having a handle assembly coupling at this location reduces the amount of torque between the handle assembly and the frame assembly when the hose reel is being pushed/pulled. Further, as the handle assembly arms are in line with the side frame assemblies, this configuration is generally considered more attractive than the offset handles of the prior art.

### BRIEF DESCRIPTION OF THE DRAWINGS

A full understanding of the invention can be gained from the following description of the preferred embodiments when read in conjunction with the accompanying drawings in which:

FIG. 1 is an isometric view of a hose reel with the handle assembly in a first position.

FIG. 2 is an exploded detail view of the basket assembly and side frames.

FIG. 3 is a partially exploded detailed view of the hose reel.

FIG. 4 is an isometric view with the handle assembly in a second position.

FIG. 5 is a isometric view looking upwardly at a hub with the handle assembly in a first position.

### DESCRIPTION OF THE PREFERRED EMBODIMENTS

As used herein, an “annular coupling” is a structure defining a substantially circular opening. The structure may define an opening that is a complete circle or a partial circle that is greater than a semi-circle, i.e. “C” shaped.

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other. The fixed components may, or may not, be directly coupled to each other.

As used herein, the word “unitary” means a component is created as a single piece or unit. That is, a component that includes pieces that are created separately and then coupled together as a unit is not a “unitary” component or body.

As used herein a “handle” is an element that is generally structured to be grasped by a user and not an element that is merely capable of being grasped. For example, a wheelbarrow frame assembly may have a plurality of elongated members that may be grasped, but only the handles are structured, i.e. positioned and sized, to be grasped by the user.

As used herein, a “grip” is the portion of a handle structured to be gripped by a user. A “grip” includes a portion of a handle having a sufficient, substantially straight length of handle to accommodate the width of four fingers, and may also include a textured surface on the handle and/or a padded portion of the handle. A “grip” must be distinguishable from other portions of the handle. For example, a smooth, straight broomstick is a handle without an identifiable grip because no portion of the handle is different than any other portion.

As described below, there are several components of the hose reel that have similar corresponding components, often a mirror image component. It is understood when two components are being described, subsequent pairs of reference numbers relate to the respective components. For example, as set forth below, side frame assemblies 26, 28 each include a hub 32, 34 each having an opening 36, 38. This means that side frame assembly 26 has a hub 32 with an opening 36 and side frame assembly 28 has a hub 34 with an opening 38.

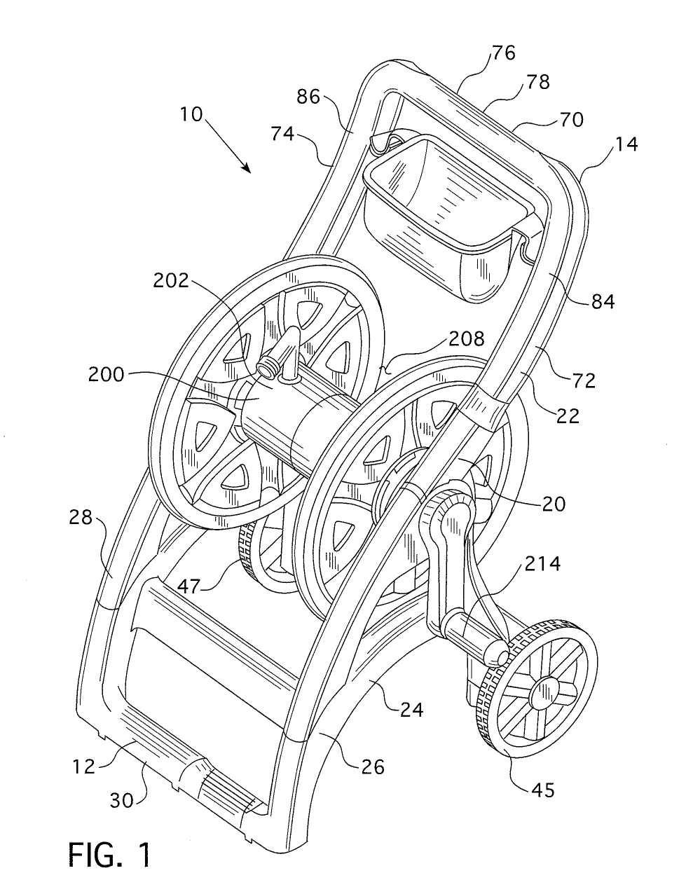

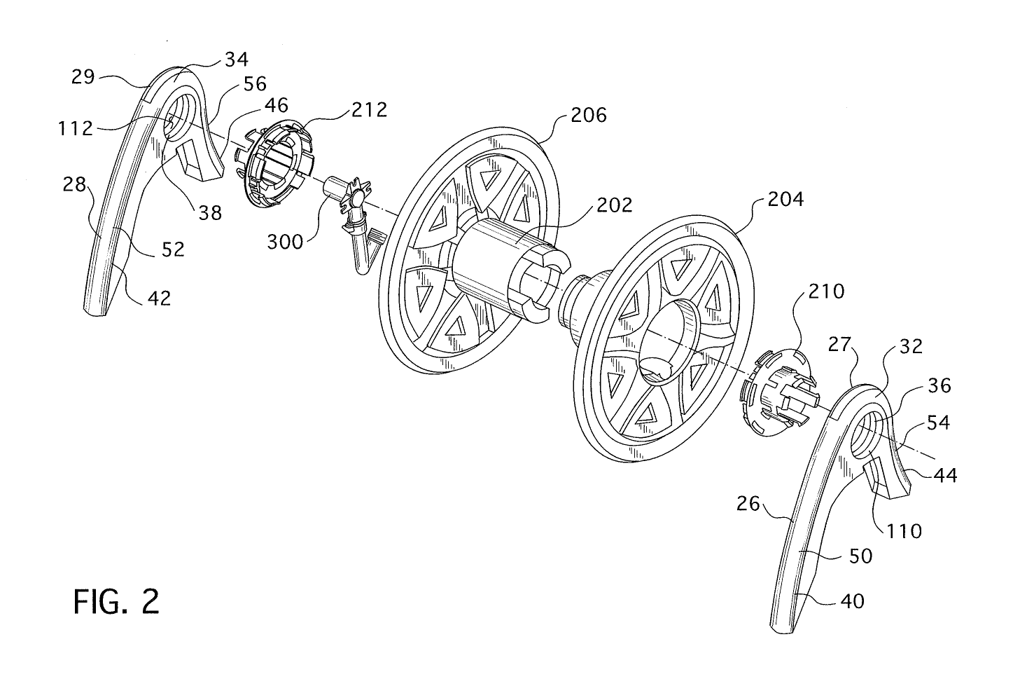

As shown in FIG. 1, a hose reel 10 includes a frame assembly 20, a rotating basket assembly 200, and a water conduit assembly 300. The hose reel 10 has a front side 12 and a rear side 14. The frame assembly 20 is made from plastic components. The frame assembly 20 includes a handle assembly 22 and a lower frame assembly 24. The lower frame assembly 24 is structured to rotatably support the basket assembly 200. The lower frame assembly 24 includes two substantially similar side frame assemblies, a first side frame assembly 26 and a second side frame assembly 28. The two side frame assemblies 26, 28 are maintained in a spaced relation by the basket assembly 200 and/or one or more elongated cross frame members 30. As shown in FIG. 2, the side frame assemblies 26, 28 each include a hub 32, 34 each having circular opening 36, 38 therethrough, a forward support member 40, 42, and a rear support member 44, 46. Further, a wheel 45, 47 (FIG. 1) may be rotatably coupled to each side frame assembly 26, 28. The hub 32, 34 and support members 40, 42, 44, 46 of each side frame assembly 26, 28 are, generally, disposed in a plane. That is, the side frame assemblies 26, 28 are generally planar.

Each hub 32, 34, and more specifically each hub opening 36, 38 is structured to rotatably support the basket assembly 200. That is the basket assembly 200 includes a cylindrical barrel 202. At each end of the barrel 202 there is a radially extending flange 204, 206. The space about the barrel 202 and in between the two flanges 204, 206 define the basket 208 which is the space in which the hose reel hose (not shown) is disposed. That is, the hose reel hose is wrapped about the barrel 202. The basket assembly 200 further includes a bifurcated axle having two portions 210, 212. That is, at each end of the barrel 202 there is an axially extending axle 210, 212 wherein the axles 210, 212 are substantially aligned about a common axis, thereby defining a single axle. The axles 210, 212, preferably, are hollow cylinders having a radius that is less than the radius of the barrel 202. As is known, a portion of the water conduit assembly 300 extends through one axle 212 and is structured to supply water to the hose reel hose. A basket handle or crank 214 (FIG. 1) is fixed to the barrel 202. Preferably, the axles 210, 212 have a sufficient length so as to extend through, but not generally beyond, the hubs 32, 34. Further, the hub openings 36, 38, preferably, do not have a radius that is significantly larger than the radius of the axles 210, 212.

Turning back to the side frame assemblies 26, 28, the support members 40, 42, 44, 46 each descend from the associated hub 32, 34 with the forward support members 40, 42 extending toward the hose reel front side 12 and the rear support members 44, 46 extending toward the hose reel rear side 14. That is, the side frame assemblies 26, 28 generally resemble an inverted “V” with the hub 32, 34 at the vertex. Further, the first side frame assembly wheel 45 is rotatably disposed at the distal, lower end of the first rear support member 44. Similarly, the second side frame assembly wheel 47 is rotatably disposed at the distal, lower end of the second rear support member 46. In one embodiment, the side frame assemblies 26, 28 are molded as unitary components.

Each support member, 40, 42, 44, 46 is elongated and has a lateral width, i.e. a width normal to the plane of the side frame assemblies 26, 28. Each hub 32, 34 has a similar width. Each support member, 40, 42, 44, 46 has an upper surface 50, 52, 54, 56 that is substantially smooth. That is, the upper surfaces 50, 52, 54, 56 are generally free from mold lines, openings, couplings, etc. Each support member upper surface 50, 52, 54, 56 may be arcuate. That is, each support member, 40, 42, 44, 46 may have a cross-section shaped, generally, as an inverted “U.”

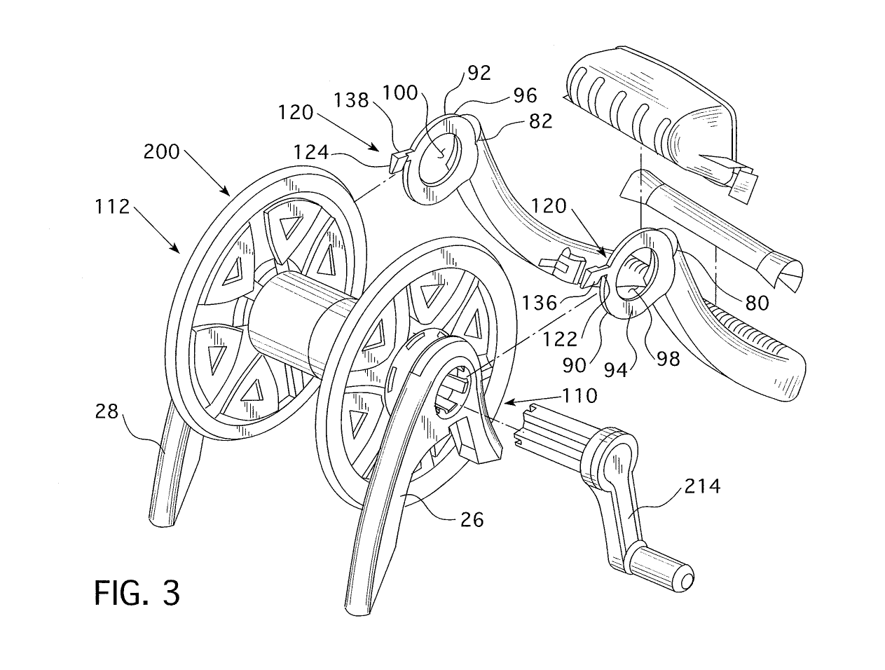

As shown in FIG. 1, the handle assembly 22 includes a generally U-shaped handle assembly body 70 with an elongated, first arm 72, an elongated second arm 74, a handle member 76. That is, the handle assembly body 70 has two tines, i.e. the arms 72, 74, and a bight, i.e. the handle member 76. The handle member 76 may include a textured surface defining a grip 78. Each arm 72, 74 has a distal end 80, 82 (FIG. 3). Similar to the support members, 40, 42, 44, 46, the handle assembly arms 72, 74 have an upper surface 84, 86 that is substantially smooth. Further, and still similar to the support members, 40, 42, 44, 46, the handle assembly arm upper surfaces may be arcuate and the arms may have a cross-section shaped, generally, as an inverted “U.”

As shown in FIG. 3, a first annular coupling 90 is disposed at the first arm distal end 80. A second annular coupling 92 is disposed at the second arm distal end 82. Each annular coupling 90, 92 is, preferably, a substantially planar body 94, 96 which define a substantially circular opening 98, 100. Each circular opening 98, 100 is sized to be disposed about the axles 210, 212.

Preferably, the outer perimeter of each annular coupling body 94, 96 is substantially circular as well. Each annular coupling 90, 92 is, preferably, formed from a foamed plastic. Foamed plastic tends to have a less pleasing appearance; this, however, is not an issue for the disclosed annular couplings 90, 92 as the annular couplings 90, 92 are disposed within the two side frame assemblies 26, 28.

That is, as shown in FIG. 2, the first side frame assembly 26 includes a first slot 27. The first slot 27 extends generally parallel to, or within, the plane of the first side frame assembly 26. The first slot 27 is sized to allow the first annular coupling 90 to pass therethrough. Similarly, the second side frame assembly 28 includes a second slot 29. The second slot 29 extends generally parallel to, or within, the plane of the second side frame assembly 28. The second slot 29 is sized to allow the second annular coupling 92 to pass therethrough. The first slot 27 is disposed on the first hub 32. The plane of the first slot 27 is generally perpendicular to the axis of the first circular opening 36. The second slot 29 is disposed on the second hub 34. The plane of the second slot 29 is generally perpendicular to the axis of the second circular opening 38.

The handle assembly 22 is rotatably coupled to the lower frame assembly 24 as follows. The first annular coupling 90 is passed through the first side frame assembly first slot 27. The second annular coupling 92 is passed through the second side frame assembly second slot 29. Each annular coupling opening 98, 100 is substantially aligned with the adjacent hub opening 36, 38 so as to form a passage 110, 112 through each side frame assembly 26, 28. The basket assembly 200 is then positioned between the two side frame assemblies 26, 28 with each axles 210, 212 extending through one passage 110, 112. It is noted that the annular coupling openings 98, 100 are sized to allow the axles 210, 212 to rotate freely therein. Thus, the basket assembly 200 is free to rotate about its axis. Moreover, in this configuration the first and second annular couplings 90, 92 are disposed about said axis of rotation. As this is the location where the handle assembly 22 is coupled to the lower frame assembly 24, and as this location is not offset from the basket assembly 200 (which, during use, is typically the heaviest component of the hose reel 10), the amount of stress, including torque, that the handle assembly 22 is subjected to is reduced compared to hose reels having an offset handle. It is further noted that the foamed plastic annular couplings 90, 92 are disposed within the side frame assemblies 26, 28 and, as such, are substantially not visible to the user.

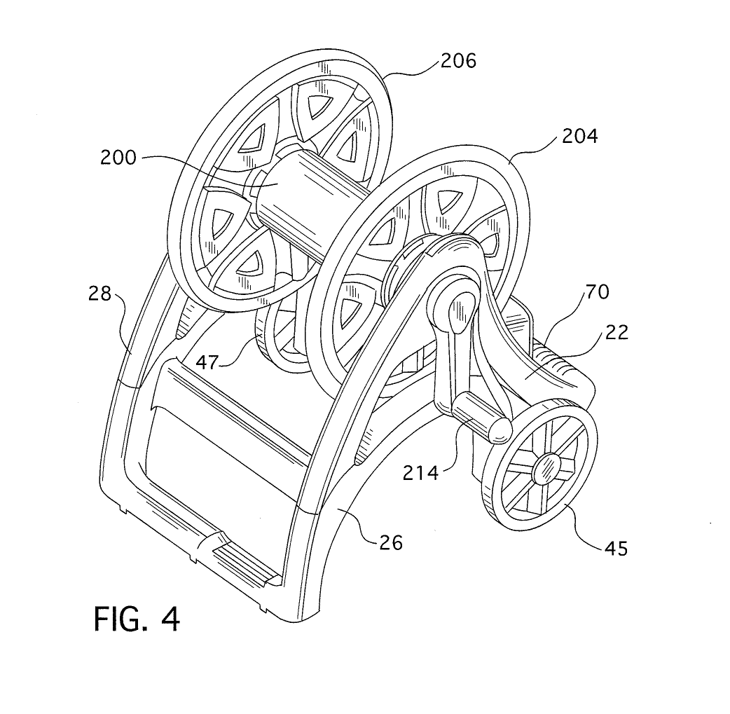

In this configuration, the handle assembly 22 may move between an upper first position (FIG. 1) and a lower second position (FIG. 4). Generally, the handle assembly 22 is placed in the upper position when the user is moving the hose reel 10 from one location to another. That is, a user applies a slight downward pressure, or horizontal pressure, to the handle member 76 thereby causing the hose reel 10 to rotate about the wheels 45, 47 and lifting the lower ends of the forward support members 40, 42 off the ground.

When the handle assembly 22 moves between the first and second positions, the first and second arms 72, 74 also move between an upper first position and a lower second position. It is noted that, unlike the prior art wherein the handle moves to the front 12 of the hose reel 10 in the lower position, in this embodiment when the first and second arms 72, 74 are in the first position, the handle assembly body 70 extends toward the lower frame assembly 24 rear side 14, and when the first and second arms 72, 74 are in the second position, said handle assembly body 70 extends toward said lower frame assembly 24 rear side 14 as well.

Further, in this configuration, the first arm 72 is generally disposed in, and moves in, the plane of the first side frame assembly 26. Similarly, the second arm 74 is generally disposed in, and moves in, the plane of the second side frame assembly 28. That is, unlike the typical hose reel wherein the handle arms are offset from the lower frame, the arms 72, 74 of the present handle assembly 22 are aligned in the same plane as the side frame assembly 26, 28 to which they are coupled. This alignment may also be described as having the handle arm 72, 74 “in-line” with the lower frame assembly 24. In this configuration, and when the handle assembly 22 is in the upper position, the arm upper surfaces 84, 86 and the forward support member upper surfaces 50, 52 are substantially aligned at the interface of the arm distal ends 80, 82 and the adjacent forward support member 40, 42. This in-line, smooth interface is generally considered to be more attractive than the couplings known in the prior art.

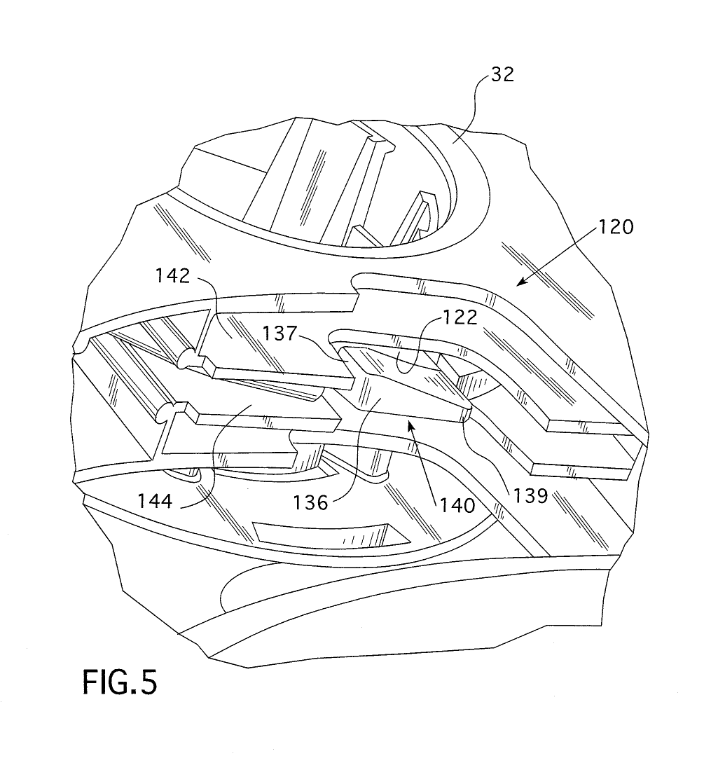

Preferably, as shown in FIG. 5, the handle assembly 22 includes a locking device 120 structured to maintain the handle assembly body 70 in at least one of the first position or said second position, and more preferably in the first position. In one embodiment, the locking device 120 includes a tab 122 extending from each handle arm 72, 74 or annular coupling 90, 92 (only one side shown). Each tab 122 extends generally in the plane of rotation of the arms 72, 74. That is, the tab 122 extends generally radially relative to the axis of rotation of the handle assembly body 70. The tab 122 is structured to be stiff, but slightly flexible. That is, each tab 122 may be flexed, yet will return to its original configuration. Further, the force required to flex each tab 122 can be applied by a typical human adult without the use of tools. Each tab 122 preferably, includes a short perpendicular extension 136. That is, the perpendicular extension 136 extend from the tab 122 in a direction generally parallel to the axis of rotation of the handle assembly body 70. More preferably, the perpendicular extensions 136 are wedge-shaped. That is, the perpendicular extensions 136 are elongated in a direction tangential to the axis of rotation of the handle assembly body 70. The front edge 137 of each perpendicular extension 136 is thicker than the back edge 139. The thickness of the tab front edge 137 is less thick than the spacing of the spaced planar members 142, 144 (discussed below). Each perpendicular extension 136, 138 is structured to fit within a corresponding socket 140 [(reference number used for all sockets) located in lower frame assembly 24.

That is, the lower frame assembly 24 defines a socket 140 which is pocket sized to accommodate one perpendicular extension 136. As noted above, in one embodiment the lower frame assembly 24 has a lateral thickness and may further include spaced planar members 142, 144. The spaced planar members 142, 144 extend about the hubs 32, 34. Thus, the spaced planar members 142, 144 define an arcuate passage 146 about each hub 32, 34. At an accessible location, preferably at the bottom of each hub 32, 34, the outer planar member 142 includes the socket 140. The sockets 140 are positioned on the lower frame assembly 124 so that the perpendicular extensions 136, 138 engage the sockets 140 when the handle assembly 22 is, preferably, in the first position.

That is, when the handle assembly 22 is in the first position, the tab 122 is aligned with a socket 140 and the perpendicular extensions 136 are disposed in the sockets 140. Further, each perpendicular extension front edge 137 engages the edge of the socket 140, thereby preventing the handle assembly 22 from rotating. A user may apply an axial force to the tab 122 thereby causing the tab 122 to flex inwardly. This motion moves the perpendicular extension 136 into the space between the spaced planar members 142, 144. That is, each perpendicular extension front edge 137 no longer engages the edge of the socket 140, thereby allowing the handle assembly 22 to rotate.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A handle assembly for a hose reel, said hose reel having a lower frame assembly and a basket assembly, said basket assembly having a cylindrical barrel with an axis, said basket assembly rotatably coupled to said frame assembly and structured to rotate about said axis, said handle assembly comprising:
a generally U-shaped handle assembly body with an elongated, first arm and an elongated second arm, each said arm having a distal end;
a first annular coupling disposed at said first arm distal end;
a second annular coupling disposed at said second arm distal end; and
wherein said first and second annular couplings are structured to be rotatably coupled to said frame assembly and disposed about said axis of rotation.

2. The handle assembly of claim 1 wherein said lower frame assembly has a first, generally planar side frame assembly and a second generally planar side frame assembly, said first and second side frame assemblies disposed in generally parallel planes, and wherein:
said first arm is generally disposed in the plane of said first side frame assembly and structured to move in said plane between an upper first position and a lower second position; and
said second arm is generally disposed in the plane of said second side frame assembly and structured to move in said plane between an upper first position and a second lower position.

3. The handle assembly of claim 2 wherein, said hose reel has a front side and a back side, said lower frame assembly further including a pair of wheels, a first wheel and a second wheel, said first and second wheels disposed at the lower, back side of said hose reel, and wherein:
when said first and second arms are in said first position, said handle assembly body extends toward said hose reel back side; and
when said first and second arms are in said second position, said handle assembly body extends toward said hose reel back side.

4. The handle assembly of claim 2 wherein, said lower frame assembly first side frame assembly includes a first slot, said first slot extending generally parallel to, or within, the plane of said first side frame assembly, said lower frame assembly second side frame assembly includes a second slot, said second slot extending generally parallel to, or within, the plane of said second side frame assembly, and wherein:
said first annular coupling has a substantially planar body, said first annular coupling body sized to pass through said first slot; and
said second annular coupling has a substantially planar body, said second annular coupling body sized to pass through said second slot.

5. The handle assembly of claim 2 wherein said basket assembly includes a first axle and a second axle, each said axle being substantially circular and wherein:
said first annular coupling opening is sized to be disposed about said first axle; and
said second annular coupling opening is sized to be disposed about said second axle.

6. The handle assembly of claim 2 wherein at least one of said first and second annular coupling includes a locking device structured to maintain said handle assembly body in at least one of said first position or said second position.

7. The handle assembly of claim 6 wherein said lower frame assembly includes at least one socket, and wherein:
each said locking device is a tab having a perpendicular extension wherein each said extension is structured to be releasably locked in one of said side frame assembly sockets.

8. The handle assembly of claim 2 wherein said lower frame assembly has a front side and a back side, said first side frame assembly further including a first hub and a first forward support member, said first forward support member extending forwardly and downwardly from said first hub, said second side frame assembly further including a second hub and a second forward support member, said second forward support member extending forwardly and downwardly from said second hub, each said forward support member having a substantially smooth upper surface, and wherein:
said first arm has a substantially smooth upper surface;
said second arm has a substantially smooth upper surface;
wherein, when said handle assembly body is in said first position, said first arm distal end abuts said first forward support member and wherein, at the interface of said first arm distal end and said first forward support member, said first arm upper surface and said first forward support member upper surface are substantially aligned; and
wherein, when said handle assembly body is in said first position, said second arm distal end abuts said second forward support member and wherein, at the interface of said second arm distal end and said second forward support member, said second arm upper surface and said second forward support member upper surface are substantially aligned.

9. The handle assembly of claim 8 wherein said first and second forward support member arms are each elongated and have an arcuate upper surface and wherein;
said first arm upper surface is arcuate and shaped to correspond to said first forward support member upper surface; and
said second arm upper surface is arcuate and shaped to correspond to said second forward support member upper surface.

10. The handle assembly of claim 1 wherein said first and second annular couplings are foamed plastic.

11. A hose reel comprising:
a frame assembly having handle assembly, a lower frame assembly and a basket assembly;
said basket assembly having a cylindrical barrel with an axis, said basket assembly rotatably coupled to said frame assembly and structured to rotate about said axis;
said handle assembly including a generally U-shaped handle assembly body with an elongated, first arm and an elongated second arm, each said arm having a distal end, a first annular coupling disposed at said first arm distal end, a second annular coupling disposed at said second arm distal end; and
wherein said first and second annular couplings are rotatably coupled to said frame assembly and disposed about said axis of rotation.

12. The hose reel of claim 11 wherein:
said lower frame assembly has a first, generally planar side frame assembly and a second generally planar side frame assembly, said first and second side frame assemblies disposed in generally parallel planes;
said first arm is generally disposed in the plane of said first side frame assembly and structured to move in said plane between an upper first position and a lower second position; and
said second arm is generally disposed in the plane of said second side frame assembly and structured to move in said plane between an upper first position and a second lower position.

13. The hose reel of claim 12 wherein:
said hose reel has a front side and a back side, said lower frame assembly further including a pair of wheels, a first wheel and a second wheel, said first and second wheels disposed at the lower, back side of said hose reel;
wherein when said first and second arms are in said first position, said handle assembly body extends toward said hose reel back side; and
wherein when said first and second arms are in said second position, said handle assembly body extends toward said hose reel back side.

14. The hose reel of claim 12 wherein:
said lower frame assembly first side frame assembly includes a first slot, said first slot extending generally parallel to, or within, the plane of said first side frame assembly;
said lower frame assembly second side frame assembly includes a second slot, said second slot extending generally parallel to, or within, the plane of said second side frame assembly;
said first annular coupling has a substantially planar body, said first annular coupling body sized to pass through said first slot; and
said second annular coupling has a substantially planar body, said second annular coupling body sized to pass through said second slot.

15. The hose reel of claim 12 wherein:
said basket assembly includes a first axle and a second axle, each said axle being substantially circular;
said first annular coupling opening is sized to be disposed about said first axle; and
said second annular coupling opening is sized to be disposed about said second axle.

16. The hose reel of claim 12 wherein at least one of said first and second annular coupling includes a locking device structured to maintain said handle assembly body in at least one of said first position or said second position.

17. The hose reel of claim 16 wherein:
said lower frame assembly includes at least one socket; and
each said locking device is a tab having a perpendicular extension wherein each said extension is structured to be releasably locked in one of said side frame assembly sockets.

18. The hose reel of claim 12 wherein:
said lower frame assembly has a front side and a back side, said first side frame assembly further including a first hub and a first forward support member, said first forward support member extending forwardly and downwardly from said first hub, said second side frame assembly further including a second hub and a second forward support member, said second forward support member extending forwardly and downwardly from said second hub, each said forward support member having a substantially smooth upper surface;
said first arm has a substantially smooth upper surface;
said second arm has a substantially smooth upper surface;
wherein, when said handle assembly body is in said first position, said first arm distal end abuts said first forward support member and wherein, at the interface of said first arm distal end and said first forward support member, said first arm upper surface and said first forward support member upper surface are substantially aligned; and
wherein, when said handle assembly body is in said first position, said second arm distal end abuts said second forward support member and wherein, at the interface of said second aim distal end and said second forward support member, said second arm upper surface and said second forward support member upper surface are substantially aligned.

19. The hose reel of claim 18 wherein:
said first and second forward support arms are each elongated and have an arcuate upper surface;
said first arm upper surface is arcuate and shaped to correspond to said first forward support member upper surface; and
said second arm upper surface is arcuate and shaped to correspond to said second forward support member upper surface.

20. The hose reel of claim 11 wherein said first and second annular couplings are foamed plastic.
